(19) United States
(12) Patent Application Publication
(10) Pub. No.: US 2025/0093106 A1
(43) Pub. Date: Mar. 20, 2025

(54) INFRARED SENSOR TURRET FOR REFLOW OVENS

(71) Applicant: INTERNATIONAL BUSINESS MACHINES CORPORATION, ARMONK, NY (US)

(72) Inventors: Abdikarim Hussein, Rochester, MN (US); Theron Lee Lewis, Rochester, MN (US); Timothy Jennings, Rochester, MN (US); James D. Bielick, Pine Island, MN (US); David J. Braun, St. Charles, MN (US); Stephen Michael Hugo, Stewartville, MN (US); John R. Dangler, Rochester, MN (US)

(21) Appl. No.: 18/470,524

(22) Filed: Sep. 20, 2023

(51) Int. Cl. F27D 21/00; G01J 5/00; G01J 5/04

(52) U.S. Cl. CPC F27D 21/0014; G01J 5/0022; G01J 5/0044; G01J 5/047

(57) ABSTRACT

An infrared sensor positioned in a reflow oven includes a reflow oven and a first IR sensor turret suspended over a conveyor surface of the reflow oven, where a directional movement of the first IR sensor turret matches a directional movement of the conveyor surface. A method for managing the IR sensor turret positioned in a reflow oven includes locating, by a first IR sensor turret, a point of interest on a PCBA, where the PCBA is positioned on a conveyor in a reflow oven. The method further includes tracking, by the first IR sensor turret, the point of interest on the PCBA, where the PCBA is moving along the conveyor in the reflow oven. The method further includes capturing, by the first IR sensor turret, a first set of thermal data at the point of interest for a first subarea of the reflow oven.

### BACKGROUND

This disclosure relates generally to reflow ovens, and in particular to infrared sensor turrets for reflow ovens.

Surface mount technology (SMT) is a primary method for assembling electronic components on printed circuit board (PCBs) utilizing reflow ovens to heat and melt solder paste to create a mechanical, electrical, and metallurgical bond between the electronic components and the PCB. Thermal profiling represents a critical part of ensuring reliable printed circuit board assemblies (PCBAs), where the electronic components are successfully coupled to the PCBs. Thermal profiling involves measuring the temperature of the PCB and the electronic components during the reflow process to ensure that a specific temperature is reach and maintained for a proper amount of time, along with controlling acceptable rates of temperature change. Thermal profiling optimizes the reflow process to ensure the solder melts and flow properly, while prevent the overheating of the electronic components and/or PCB which can result in permanent damage.

### SUMMARY

One aspect of an embodiment of the present invention discloses an apparatus for an infrared (IR) sensor turret positioned in a reflow oven, the apparatus comprising the reflow oven and a first IR sensor turret suspended over a conveyor surface of the reflow oven, wherein a directional movement of the first IR sensor turret matches a directional movement of the conveyor surface.

Another aspect of an embodiment of the present invention discloses a method for managing an infrared (IR) sensor turret positioned in a reflow oven, the method comprising locating, by a first infrared (IR) sensor turret, a point of interest on a printed circuit board assembly (PCBA), wherein the PCBA is positioned on a conveyor in a reflow oven. The method further comprising tracking, by the first IR sensor turret, the point of interest on the PCBA, wherein the PCBA is moving along the conveyor in the reflow oven. The method comprising capturing, by the first IR sensor turret, a first set of thermal data at the point of interest for a first subarea of the reflow oven.

### BRIEF DESCRIPTION OF THE SEVERAL VIEWS OF THE DRAWINGS

FIG. 1 depicts a side view of a multi-zone reflow oven with multiple infrared sensor turrets, in accordance with an embodiment of the present invention.

FIG. 2A depicts a side view of a multi-zone reflow oven with a first infrared sensor turret out of the multiple infrared sensor turrets tracking a printed circuit board assembly, in accordance with an embodiment of the present invention.

FIG. 2B depicts a side view of a multi-zone reflow oven with a first infrared sensor turret and a second infrared sensor turret tracking a printed circuit board assembly and a third infrared sensor turret anticipating the printed circuit board assembly, in accordance with an embodiment of the present invention.

FIG. 2C depicts a side view of a multi-zone reflow oven with a first infrared sensor turret anticipating another printed circuit board assembly, and a second infrared sensor turret and a third infrared sensor turret tracking a printed circuit board assembly, in accordance with an embodiment of the present invention.

FIG. 2D depicts a side view of a multi-zone reflow oven with a first infrared sensor turret and a second infrared sensor turret anticipating another printed circuit board assembly and a third infrared sensor turret tracking a printed circuit board assembly, in accordance with an embodiment of the present invention.

FIG. 3A depicts a side view of an infrared sensor turret with a full rotational turret, in accordance with an embodiment of the present invention.

FIG. 3B depicts a bottom view of an infrared sensor turret with a rotational turret, in accordance with an embodiment of the present invention.

FIG. 4A depicts a side view of an infrared sensor turret with a bidirectional turret and a rotational base, in accordance with an embodiment of the present invention.

FIG. 4B depicts a bottom view of an infrared sensor turret with a bidirectional turret and a rotational base, in accordance with an embodiment of the present invention.

FIG. 5 is a functional block diagram illustrating a computing environment, in accordance with an embodiment of the present invention.

FIG. 6 depicts a flowchart of an infrared sensor turret program for managing multiple infrared sensor turrets in a reflow oven, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

According to an aspect of the invention there is provided an apparatus that includes a reflow oven and a first infrared (IR) sensor turret suspended over a conveyor surface of the reflow oven, where a directional movement of the first IR sensor turret matches a directional movement of the conveyor surface. A first benefit of the present invention includes not scrapping cards into thermal profile test vehicles, therefore preventing a financial lost associated with the cards and the mounted electronic components, attachment of thermocouples, and the engineering/technician labor/handling time. A second benefit of the present invention includes increased control and accuracy of thermal recipes for the multiple temperature zones of the reflow oven based on the thermal data collected by the IR sensor turrets. A third benefit of the present invention includes easier detection of over temps (i.e., exceeding a threshold) through line monitoring of temperature sensitive components on a printed circuit board assembly (PCBA) positioned on the conveyor surface in the reflow oven, thus preventing out-of-control situations and reducing rework to the PCBAs along the manufacturing line. A fourth benefit of the present invention includes providing traceability within the assembly line for each PCBA that passed through the reflow oven with the IR sensor turrets.

In embodiments, the apparatus can further include an IR sensor of the first IR sensor turret directed towards a top surface of the conveyor surface, where the directional movement of the first IR sensor turret dictates a directional movement of the IR sensor of the first IR sensor turret. A benefit includes an IR sensor that tracks a movement of a point of interest (e.g., electronic component) on a PCBA, as the PCBA travels on the top surface of the conveyor surface through the reflow oven. In embodiments, the apparatus can further include an optical camera with laser of the first IR sensor turret directed towards the top surface of the conveyor surface. A benefit includes utilizing the optical camera with laser to identify the point of interest on the PCBA, as the PCBA travels on the top surface of the conveyor surface through the reflow oven. In embodiments, the apparatus can further include a first heating element positioned in a first temperature zone of the reflow oven, where an operational range of the first IR sensor turret covers a first subarea of the reflow oven beneath at least a portion of the first heat element on the conveyor surface. A benefit includes the first IR sensor turret providing thermal data reading coverage for the first subarea of the reflow oven located beneath the first heat element with the first temperature zone.

In embodiments, the apparatus can further include a second heating element positioned in a second temperature zone of the reflow oven, where the second heating element is adjacent to the first heating element, where the operational range of the first IR sensor turret covers a second subarea of the reflow oven beneath at least a portion of the second heat element on the conveyor surface. A benefit includes the first IR sensor turret also providing thermal data reading coverage for the second subarea of the reflow oven located beneath the second heat element with the second temperature zone. In embodiments, the apparatus can further include a second IR sensor turret suspended over the conveyor surface of the reflow oven, where a directional movement of the second IR sensor turret matches the directional movement of the conveyor surface. A benefit includes a second IR sensor turret to provide coverage of the conveyor surface where the first IR sensor turret may not reach. In embodiments, the apparatus can further include an operational range of the second IR sensor turret that covers a third subarea of the reflow oven beneath at least another portion of the second heat element on the conveyor surface. A benefit includes providing thermal data reading coverage for the third subarea of the reflow oven located beneath the second heat element with the second temperature zone.

In embodiments, the apparatus can further include the second subarea of the reflow oven beneath at least the portion of the second heat element on the conveyor surface that at least partially overlaps with the third subarea of the reflow oven beneath at least the portion of the second heat element on the conveyor surface. A benefit includes providing two sets of thermal data for an area of the partial overlapping of the second subarea and the third subarea.

In embodiments, the apparatus can further include a pivot ball of the first IR sensor turret mechanically coupled to a base, where the IR sensor and the optical camera with laser of the first IR sensor turret protrudes out from the pivot ball. A benefit includes the IR sensor and the optical camera being able to rotate in any direction as dictated by a movement of the pivot ball of the first IR sensor turret. In embodiments, the apparatus can further include the pivot ball that rotates in a plurality of directions with regards to the base. A benefit includes the base remaining fixed relative to the pivot ball that can rotate in any direction (i.e., a plurality of directions). In embodiments, the apparatus can further include the pivot ball that rotates in a bidirectional manner with regards to the base and the base rotates in a bidirectional manner. A benefit includes simplifying the mechanism for moving the IR sensor and the optical camera by allowing both the base and the pivot ball to move independently.

In embodiments, the apparatus can further include the first IR sensor turret that is suspended in a first gap between the first heating element and the second heating element. A benefit includes exploiting the first gap that is present in a reflow oven between two heating elements. In embodiments, the apparatus can further include the first IR sensor turret that is mechanically coupled to the first heating element. A benefit includes potentially retrofitting a reflow oven with the first IR sensor turret to the first heating element. In embodiments, the apparatus can further include the first IR sensor turret is mechanically coupled to the second heating element. A benefit includes potentially retrofitting a reflow oven with the first IR sensor turret to the second heating element. In embodiments, the apparatus can further include the first IR sensor turret is mechanically coupled to a top portion within an interior surface of the reflow oven. A benefit includes potentially retrofitting a reflow oven with the first IR sensor turret to the interior surface of the first gap of the reflow oven, between the first heating element and the second heating element.

According to an aspect of the invention there is provided a computer-implemented method that includes locating, by a first infrared (IR) sensor turret, a point of interest on a printed circuit board assembly (PCBA), where the PCBA is positioned on a conveyor in a reflow oven. The method further can includes tracking, by the first IR sensor turret, the point of interest on the PCBA, where the PCBA is moving along the conveyor in the reflow oven. The method further includes capturing, by the first IR sensor turret, a first set of thermal data at the point of interest for a first subarea of the reflow oven. A first benefit of the present invention includes not scrapping cards into thermal profile test vehicles, therefore preventing a financial lost associated with the cards and the mounted electronic components, attachment of thermocouples, and the engineering/technician labor/handling time. A second benefit of the present invention includes increased control and accuracy of thermal recipes for the multiple temperature zones of the reflow oven based on the thermal data collected by the IR sensor turrets. A third benefit of the present invention includes easier detection of over temps (i.e., exceeding a threshold) through line monitoring of temperature sensitive components on a printed circuit board assembly (PCBA) positioned on the conveyor surface in the reflow oven, thus preventing out-of-control situations and reducing rework to the PCBAs along the manufacturing line. A fourth benefit of the present invention includes providing traceability within the assembly line for each PCBA that passed through the reflow oven with the IR sensor turrets.

In embodiments, the method can further include detecting, by the first IR sensor turret, an edge of a card for the PCBA. A benefit includes utilizing the edge of the card for the PCBA as a reference point to identify the point of interest on the PCBA. In embodiments, the method can further include a first optical camera with laser of the first infrared sensor turret that detects the edge of the card for the PCBA. A benefit includes utilizing the first optical camera with laser to detect the edge of the card for the PCBA as the reference point to identify the point of interest on the PCBA. In embodiments, the method can further include a first IR sensor of the first infrared sensor turret that detects the edge of the card for the PCBA based on a temperature variation between a temperature of heated air in the reflow oven and a temperature of a surface of the edge of the card for the PCBA. A benefit includes a utilizing an IR sensor turret with only an IR sensor, where the IR sensor can detect the edge of the card.

In embodiments, the method can further include in response to determining a second IR sensor turret is available in the reflow oven, locating, by the second infrared IR sensor turret, the point of interest on the PCBA. The method can further include tracking, by the second IR sensor turret, the point of interest on the PCBA. The method can further include capturing, by the second IR sensor turret, a second set of thermal data at the point of interest for a second subarea of the reflow oven. A benefit includes utilizing a second IR sensor turret to provide additional coverage for the second subarea to collect a second set of thermal data at the point of interest on the PCBA. In embodiments, the method can further include configuring, the first IR sensor turret, from a final position to an anticipation position to detect another edge of another card for another PCBA positioned on the conveyor in the reflow oven, where a movement between the final position and the anticipation position defines an operational range of the first IR sensor turret. A benefit includes the first IR sensor turret being in a position to anticipate an arrival of another PCBA traveling along the conveyor in the reflow oven.

In embodiments, the method can further include detecting, by the first IR sensor turret, the other edge of the other card for the other PCBA. A benefit includes utilizing the edge of the card for the PCBA as a reference point to identify the point of interest on the other PCBA in a mass production setting, where multiple PCBAs are being manufactured and fed through the reflow oven. In embodiments, the method can further include a portion of the first subarea that overlaps with a portion of the second subarea. A benefit includes providing two sets of thermal data for an area of the partial overlapping of the first subarea and the second subarea. In embodiments, the method can further include the first subarea that corresponds to at least a first temperature zone associated with a first heating element in the reflow oven and a portion of a second temperature zone associated with a second heating element in the reflow oven. A benefit includes an association of the first heating element and the second heating element with the thermal data for the first subarea, so that the first heating element and/or the second heating element can be adjusted based on abnormal temperature readings (e.g., exceeding an upper threshold). In embodiments, the method can further include the second subarea that corresponds to at least the second temperature zone associated with the second heating element in the reflow oven and a portion of a third temperature zone associated with a third heating element in the reflow oven. A benefit includes an association of the second heating element and the third heating element with the thermal data for the second subarea, so that the second heating element and/or the third heating element can be adjusted based on abnormal temperature readings (e.g., below a lower threshold).

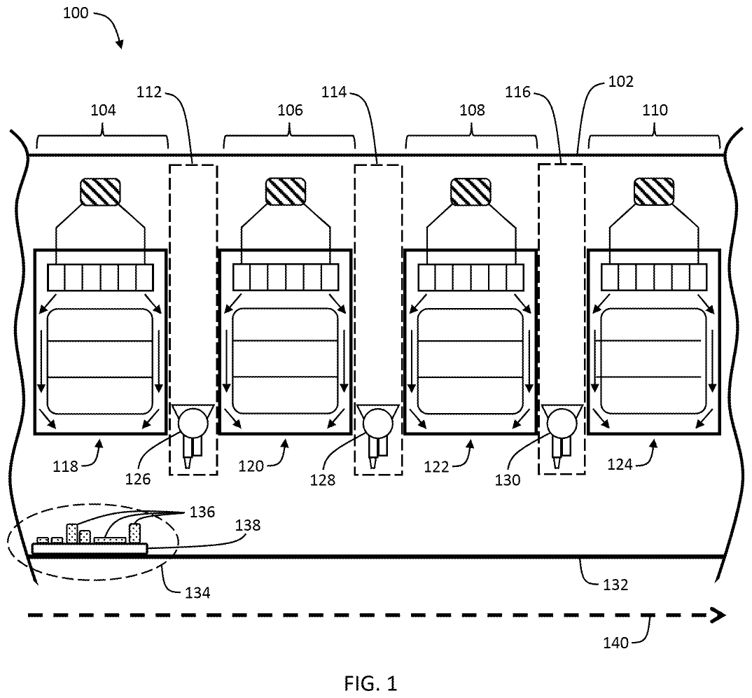

FIG. 1 depicts a side view of a multi-zone reflow oven with multiple infrared sensor turrets, in accordance with an embodiment of the present invention. Illustrated is enhanced view of a surface mount technology (SMT) reflow oven 100, where top portion 102 of reflow oven 100 includes four temperature zones. A typical reflow oven 100 includes top portion 102 and a lower portion (not illustrated in FIG. 1), where a first set of multiple heating elements in top portion 102 and a second set of multiple heating elements in the lower portion provide the heat required for the reflow soldering process. In the enhanced view of reflow oven 100, the four illustrated temperature zones are designated first temperature zone 104, second temperature zone 106, third temperature zone 108, and fourth temperature zone 110. First gap 112 separates first temperature zone 104 and second temperature zone 106 in top portion 102, second gap 114 separates second temperature zone 106 and third temperature zone 108 in top portion 102, and third gap 116 separates third temperature zone 108 and fourth temperature zone 110 in top portion 102.

First heating element 118 positioned in first temperature zone 104 in top portion 102 is adjacent to second heating element 120 positioned in second temperature zone 106 in top portion 102. Second heating element 120 positioned in second temperature zone 106 in top portion 102 is adjacent to third heating element 122 is positioned in third temperature zone 108 in top portion 102. Third heating element 122 positioned in third temperature zone 108 in top portion 102 is adjacent to fourth heating element 124 positioned in fourth temperature zone 110 in top portion 102. Each of first temperature zone 104, second temperature zone 106, third temperature zone 108, and fourth temperature zone 110 can include another set of heating elements positioned in the lower portion of reflow oven 100, not illustrated in FIG. 1.

First infrared (IR) sensor turret 126 is positioned in first gap 112, second IR sensor turret 128 is positioned in second gap 114, and third IR sensor turret 130 is positioned in third gap 116. In one embodiment, first sensor turret 126, second IR sensor turret 128, and third sensor turret 130 are mechanically coupled to an interior surface of top portion 102 of reflow oven 100, where each of first sensor turret 126, second IR sensor turret 128, and third sensor turret 130 are suspended over conveyor surface 132. Each of first sensor turret 126, second IR sensor turret 128, and third sensor turret 130 can match a directional movement of conveyor surface 132. In another embodiment, first sensor turret 126 is mechanically coupled to first heating element 118 and/or second heating element 120, second IR sensor turret 128 is mechanically coupled to second heating element 120 and/or third heating element 122, and third sensor turret 130 is mechanically coupled to third heating element 122 and/or fourth heating element 124, where each of first sensor turret 126, second IR sensor turret 128, and third sensor turret 130 are suspended over conveyor surface 132.

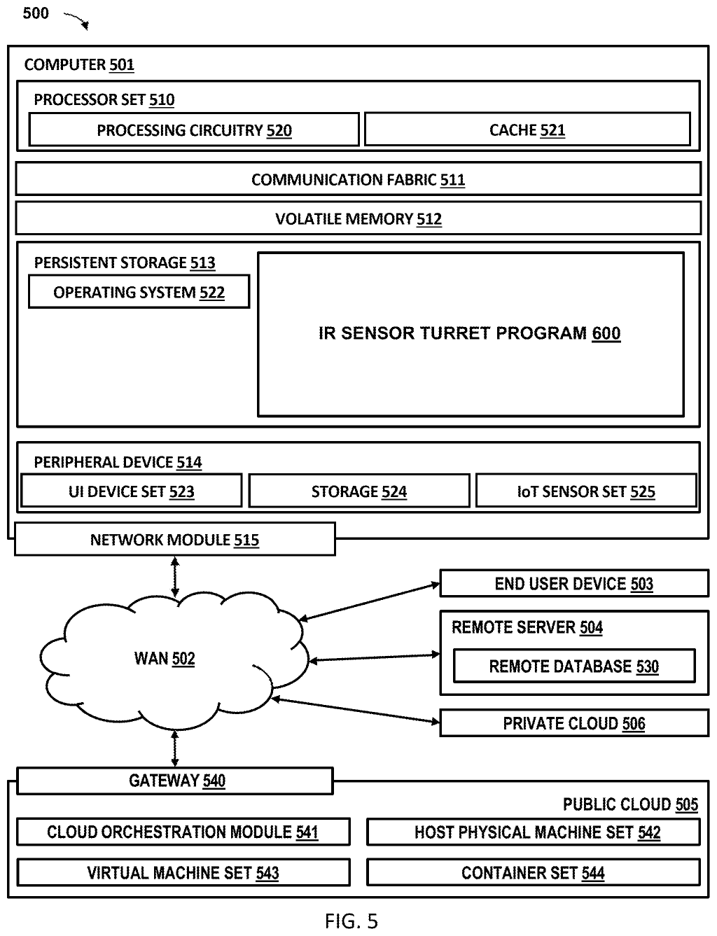

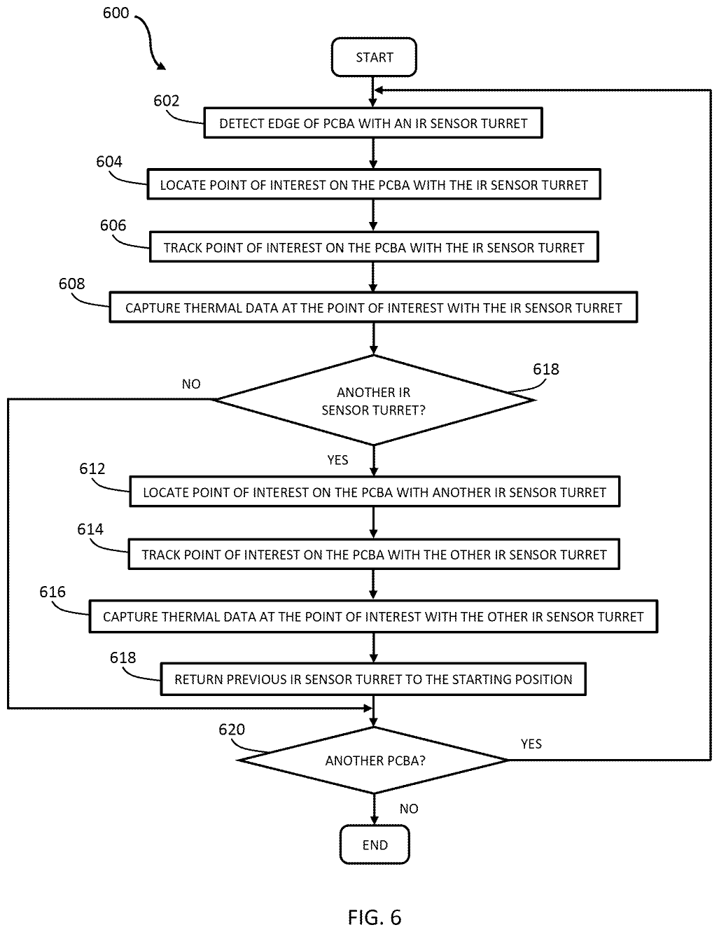

Each of first sensor turret 126, second IR sensor turret 128, and third sensor turret 130 are suspended over conveyor surface 132 such that a movement of an IR sensor for each of first sensor turret 126, second IR sensor turret 128, and third sensor turret 130 provides full coverage or overlapping full coverage of conveyor surface 132. Full coverage indicates that a length and a width of a subarea of conveyor surface 132 is covered by one IR sensor and overlapping full coverage indicates that a length and a width of a subarea of conveyor surface 132 is covered by two or more IR sensors. A subarea represents a portion of the reflow oven (i.e., one or more temperatures zones) beneath one or more heating elements. Conveyor surface 132 can be part of a rail-based or belt-based conveyor system. One or more actions performed by each of first sensor turret 126, second IR sensor turret 128, and third sensor turret 130 are controlled by IR sensor turret program 600, discussed in further detail with regards to FIGS. 5 and 6.

In this embodiment, printed circuit board assembly (PCBA) 134 includes electronic components 136 disposed on printed circuit board (PCB) 138, where solder paste temporarily affixes the electronic components 136 to PCB 138 until the reflow soldering process is complete. In another embodiment, PCBA 134 includes electronic components 136 temporarily affixed to a top portion and a bottom portion of PCB 138. The reflowing soldering process results in the solder paste turning into a molten state, creating permanent solder joints when cooled between electronic components 136 and PCB 138 for PCBA 134. PCBA 134 is disposed on top of conveyor surface 132, where directional arrow 140 indicates a movement direction of PCBA 134 through reflow oven 100. Therefore, a movement of PCBA 134 along conveyor surface 132 includes moving from first temperature zone 104 to second temperature zone 106, second temperature zone 106 to third temperature zone 108, and third temperature zone 108 to fourth temperature zone 110.

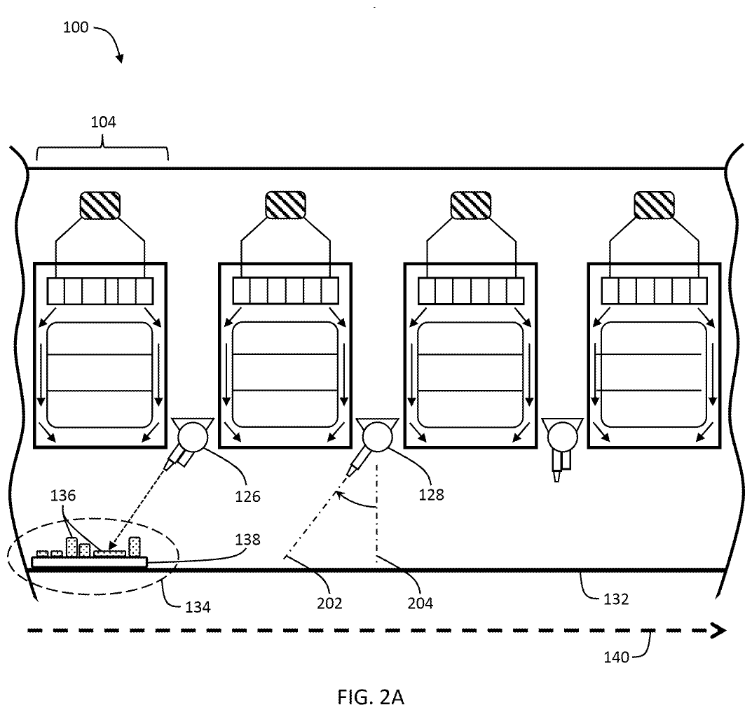

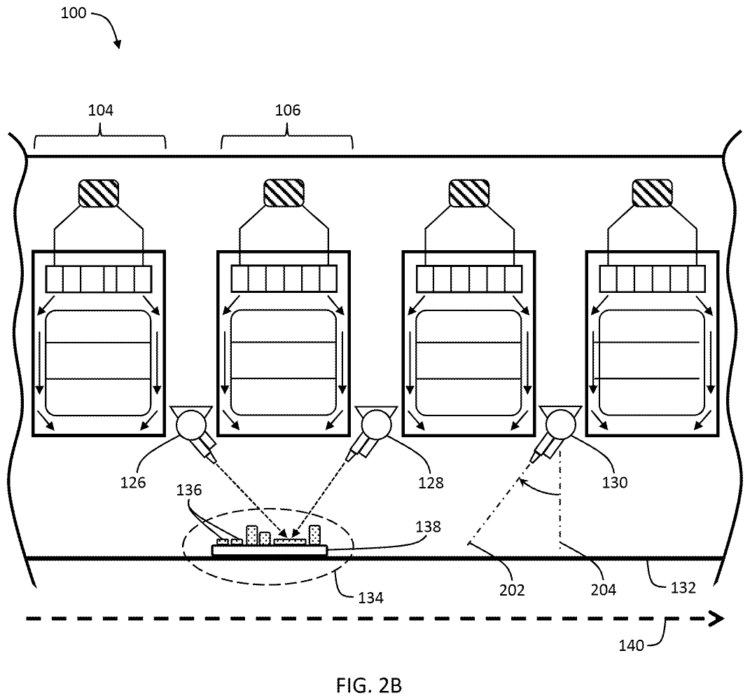

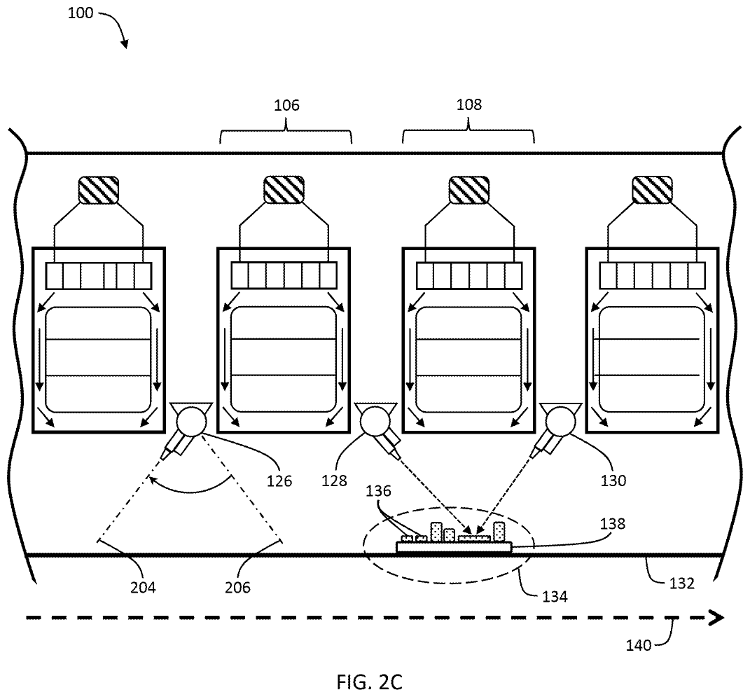

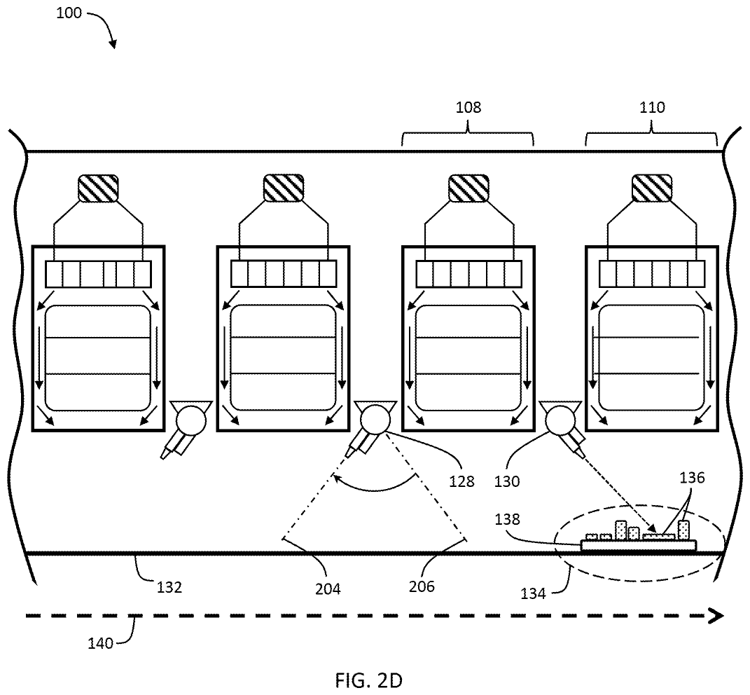

As PCBA 134 passes through first temperature zone 104, first IR sensor turret 126 locates and captures temperature data at a point of interest, such as, a specific electronic component from electronic components 136 on PCB 138. As PCBA 134 passes between first temperature zone 104 and second temperature zone 106, first IR sensor turret 126 captures temperature data at the point of interest while second IR sensor turret 128 locates and starts to capture temperature data at the point of interest. As PCBA 134 passes through second temperature zone 106, second IR sensor turret 128 continues capturing temperature data at the point of interest, while first IR sensor turret 126 configures into a position to await another PCBA 134 (not illustrated in FIG. 1) traveling along conveyor surface 132. As PCBA 134 passes between second temperature zone 106 and third temperature zone 108, second IR sensor turret 128 continues capturing temperature data at the point of interest while third IR sensor turret 130 locates and starts to capture temperature data at the point of interest. As PCBA 134 passes through third temperature zone 108, third IR sensor turret 130 continues capturing temperature data at the point of interest, while second IR sensor turret 128 configures into a position to await another PCBA 134 (not illustrated in FIG. 1) traveling along conveyor surface 132. As PCBA 134 passes between third temperature zone 108 and fourth temperature zone 110, third IR sensor turret 130 continues capturing temperature data at the point of interest until PCBA 134 passes through fourth temperature zone 110 and exits into one or more cooling zones of reflow oven 100 along conveyor surface 132, not illustrated in FIG. 1. FIGS. 2A through 2D illustrate the movement of PCBA 134 through the four temperature zones of reflow oven 100.

FIG. 2A depicts a side view of a multi-zone reflow oven with a first infrared sensor turret out of the multiple infrared sensor turrets tracking a printed circuit board assembly, in accordance with an embodiment of the present invention. As PCBA 134 enters first temperature zone 104, first IR sensor turret 126 locates an edge of PCBA 134 and based on the located edge of PCBA 134, first IR sensor turret 126 locates a point of interest on PCBA 134. Conveyor surface 132 can utilize a fixture for securing PCBA 134 onto conveyor surface 132 as it travels through reflow oven 100. Based on the dimensions of the fixture and a spacing between other fixtures on conveyor surface 132, first IR sensor turret 126 can locate the edge of PCBA 134. Alternatively, first IR sensor turret 126 can locate an edge of PCBA 134 based on captured temperature change, since there is a temperature variation between a top surface of PCBA 134 and a top surface of conveyor surface 132. In this embodiment, a first electronic component of electronic components 136 on PCB 138 represents the point of interest that first IR sensor turret 126 locates. As PCBA 134 passes through first temperature zone 104, first IR sensor turret 126 captures temperature data at the point of interest. Based on the direction of travel as designated by directional arrow 140 for conveyor surface 132 and a speed of movement of conveyor surface 132, second IR sensor turret 128 anticipates an arrival of PCBA 134 on conveyor surface 132 by transitioning from standby position 202 to anticipation position 204.

FIG. 2B depicts a side view of a multi-zone reflow oven with a first infrared sensor turret and a second infrared sensor turret tracking a printed circuit board assembly and a third infrared sensor turret anticipating the printed circuit board assembly, in accordance with an embodiment of the present invention. As PCBA 134 passes between first temperature zone 104 and second temperature zone 106, second IR sensor turret 128 locates the edge of PCBA 134 and based on the located edge of PCBA 134, second IR sensor turret 128 locates the point of interest on PCBA 134 being tracked by first IR sensor turret 126. As PCBA 134 passes through second temperature zone 106, both first IR sensor turret 126 and second IR sensor turret 128 capture temperature data at the point of interest. With both first IR sensor turret 126 and second IR sensor turret 128 capturing temperature data, discrepancies can be identified, and any faulty IR sensor turret can be repaired or replaced. Based on the direction of travel as designated by directional arrow 140 for conveyor surface 132 and the speed of movement of conveyor surface 132, third IR sensor turret 130 anticipates an arrival of PCBA 134 on conveyor surface 132 by transitioning from standby position 202 to anticipation position 204.

FIG. 2C depicts a side view of a multi-zone reflow oven with a first infrared sensor turret anticipating another printed circuit board assembly, and a second infrared sensor turret and a third infrared sensor turret tracking a printed circuit board assembly, in accordance with an embodiment of the present invention. As PCBA 134 passes between second temperature zone 106 and third temperature zone 108, third IR sensor turret 130 locates the edge of PCBA 134 and based on the located edge of PCBA 134, third IR sensor turret 130 locates the point of interest on PCBA 134 being tracked by second IR sensor turret 128. As PCBA 134 passes through third temperature zone 108, both second IR sensor turret 128 and third IR sensor turret 130 capture temperature data at the point of interest. Since PCBA 134 passed a data capture range of first IR sensor turret 126 for capturing temperature data at the point of interest, first IR sensor turret 126 anticipates an arrival of another PCBA on conveyor surface 132 by transitioning from final position 206 to anticipation position 204. Final position 206 represents a maximum position for the data capture range of first IR sensor turret 126.

FIG. 2D depicts a side view of a multi-zone reflow oven with a first infrared sensor turret and a second infrared sensor turret anticipating another printed circuit board assembly and a third infrared sensor turret tracking a printed circuit board assembly, in accordance with an embodiment of the present invention. As PCBA 134 passes between third temperature zone 108 and fourth temperature zone 110, a data capture range of second IR sensor turret 128 for capturing temperature data at the point of interest is reached. As a result, second IR sensor turret 128 anticipates an arrival of another PCBA on conveyor surface 132 by transitioning from final position 206 to anticipation position 204. Final position 206 represents a maximum position for the data capture range of second IR sensor turret 128. Third IR sensor turret 130 continues capturing temperature data at the point of interest until PCBA 134 passes through fourth temperature zone 110 and exits into one or more cooling zones of reflow oven 100 along conveyor surface 132, not illustrated in FIG. 2D.

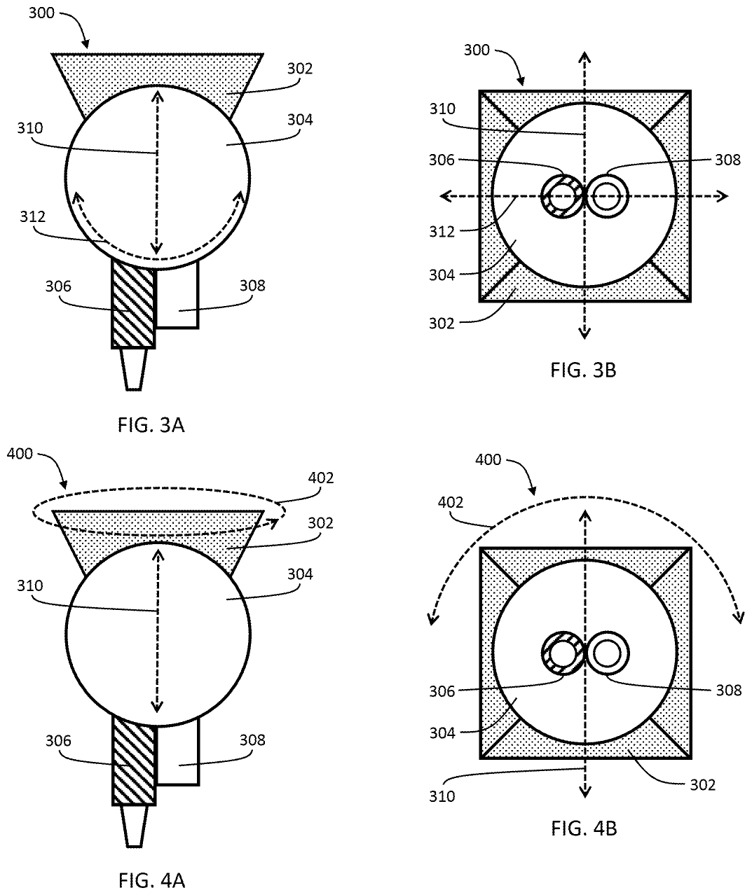

FIG. 3A depicts a side view of an infrared sensor turret with a full rotational turret, in accordance with an embodiment of the present invention. In this embodiment, first example IR sensor turret 300 represents each of first IR sensor turret 126, second IR sensor turret 128, and third IR sensor turret 130 from FIG. 1 through 2D. First example IR sensor turret 300 includes base 302, pivot ball 304, IR sensor 306, and optional device 308, where optional device 308 can be an optical camera with laser. IR sensor 306 and optional device 308 protrude out of pivot ball 304. Pivot ball 304 is mechanically coupled to base 302, where pivot ball 304 can rotate in any direction as illustrated by directional arrows 310 and 312. In one embodiment, one or more motors are coupled to one or more rack and pinion sets to provide the rotational movement of pivot ball 304, where the one or more motors are coupled to base 302, and the one or more rack and pinion sets are coupled to pivot ball 304. The one or more motors coupled to base 302 mechanically interact with the one or more rack and pinion sets to provide the rotational movement of pivot ball 304 designated by directional arrows 310 and 312. In another embodiment, one or more actuators provide the rotational movement of pivot ball 304, where the one or more actuators are coupled to base 302 and to pivot ball 304. The one or more actuators coupled to base 302 and pivot ball 304 provide the rotational movement of pivot ball 304 designated by directional arrows 310 and 312. A directional movement of first example IR sensor turret 300 dictates a directional movement of IR sensor 306 and optional device 308.

FIG. 3B depicts a bottom view of an infrared sensor turret with a rotational turret, in accordance with an embodiment of the present invention. From the embodiment discussed in FIG. 3A, first example IR sensor turret 300 represents each of first IR sensor turret 126, second IR sensor turret 128, and third IR sensor turret 130 from FIG. 1 through 2D. First example IR sensor turret 300 includes base 302, pivot ball 304, IR sensor 306, and optional device 308. Pivot ball 304 is mechanically coupled to base 302, where pivot ball 304 can rotate in any direction as illustrated by directional arrows 310 and 312. In this bottom view of first example IR sensor turret 300, pivot ball 304 with IR sensor 306 and optional device 308 can rotate in any direction along as designated by directional arrow 310 and 312.

FIG. 4A depicts a side view of an infrared sensor turret with a bidirectional turret and a rotational base, in accordance with an embodiment of the present invention. In this embodiment, second example IR sensor turret 400 represents each of first IR sensor turret 126, second IR sensor turret 128, and third IR sensor turret 130 from FIG. 1 through 2D. Second example IR sensor turret 400 includes base 302, pivot ball 304, IR sensor 306, and optional device 308, where optional device 308 can be an optical camera with laser. IR sensor 306 and optional device 308 protrude out of pivot ball 304. Pivot ball 304 is mechanically coupled to base 302, where pivot ball 304 can rotate in a bidirectional manner as indicated by directional arrows 310. Base 302 of second example IR sensor turret 400 can rotate 360 degrees as indicated by directional arrow 402, perpendicular to the bidirectional rotation of pivot ball 304. In one embodiment, a first set of one or more motors are coupled to one or more rack and pinion sets to provide the bidirectional rotational movement of pivot ball 304, where the first set of one or more motors are coupled to base 302, and the one or more rack and pinion sets are coupled to pivot ball 304. The first set of one or more motors coupled to base 302 mechanically interact with the one or more rack and pinion sets to provide the bidirectional rotational movement of pivot ball 304 designated by directional arrows 310. A second set of one or more motors are coupled to base 302 to provide the 360-degree rotational movement of second example IR sensor turret 400 as indicated by directional arrow 402. In another embodiment, one or more actuators provide the bidirectional rotational movement of pivot ball 304, where the one or more actuators are coupled to base 302 and to pivot ball 304. The one or more actuators coupled to base 302 and pivot ball 304 provide the bidirectional rotational movement of pivot ball 304 designated by directional arrows 310. A directional movement of first example IR sensor turret 300 dictates a directional movement of IR sensor 306 and optional device 308.

FIG. 4B depicts a bottom view of an infrared sensor turret with a bidirectional turret and a rotational base, in accordance with an embodiment of the present invention. From the embodiment discussed in FIG. 4A, second example IR sensor turret 400 represents each of first IR sensor turret 126, second IR sensor turret 128, and third IR sensor turret 130 from FIG. 1 through 2D. Second example IR sensor turret 400 includes base 302, pivot ball 304, IR sensor 306, and optional device 308. Pivot ball 304 is mechanically coupled to base 302, where pivot ball 304 can rotate in a bidirectional manner as illustrated by directional arrows 310. Base 302 can rotate 360 degrees as illustrated by directional arrows 402. In this bottom view of first example IR sensor turret 300, pivot ball 304 with IR sensor 306 and optional device 308 can rotate in any direction along as designated by directional arrow 310 and 312.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 5 is a functional block diagram illustrating a computing environment, generally designated 500, in accordance with one embodiment of the present invention. FIG. 5 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 500 contains an example of an environment for the execution of at least some of the computer code involved in performing the inventive methods, such as, IR sensor turret program 600. In addition to block 200, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 600, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 600 in persistent storage 513.

Communication fabric 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 600 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

FIG. 6 depicts a flowchart of an infrared sensor turret program for managing multiple infrared sensor turrets in a reflow oven, in accordance with an embodiment of the present invention.

IR sensor turret program 600 detects an edge of a PCBA with an IR sensor turret (602). As previously discussed with regards to FIG. 1, an SMT reflow oven includes multiple heating zones designated temperature zones that are separated by gaps, where each gap includes an IR sensor turret. The multiple IT sensor turrets are mounted in a fixed position in multiple gaps between the multiple temperature zones throughout the length of the reflow oven. Based off electronic card dimensions, IR sensor turret program 600 can track a point of interest on the PCBA and provide thermal data for the point of interest as the PCBA travels on a conveyor through the multiple temperature zones positioned along the length of the reflow oven. As the PCBA is placed on the conveyor at a first end of the reflow oven, the conveyor moves the PCBA towards a first temperature zone from the multiple temperature zones. IR sensor turret program 600 can configure the first IR sensor turret from the multiple IR sensor turrets from a standby position to an anticipation position, where the IR sensor is directed towards an area where the edge of the PCBA is first to appear based on a direction of travel for the conveyor. In one embodiment, IR sensor turret program 600 detects the edge of the PCBA with the first IR sensor turret by utilizing an optical camera with laser. In another embodiment, IR sensor turret program 600 detects the edge of the PCBA based on a known fixture location in which the PCBA is positioned and a speed of the conveyor moving the PCBA through the reflow oven. In yet another embodiment, IR sensor turret program 600 detects the edge of the PCBA with the first IR sensor turret by utilizing an IR sensor to detect a temperature variation between a temperature of heated air in the first temperature zone of the reflow oven and a temperature of a surface of the edge of the PCBA.

IR sensor turret program 600 locates a point of interest on the PCBA with the IR sensor turret (604). In one embodiment, IR sensor turret program 600 utilizes known dimensions for the PCBA and known coordinates to locate the point of interest on the PCBA with the IR sensor turret. Since the IR sensor turret program 600 detects the edge of a PCBA and the PCBA is in a fixed position on the conveyor, IR sensor turret program 600 utilizes the edge of PCBA as a point of reference and the speed of the conveyor when utilizes the known coordinates to locate the point of interest. As the PCBA travels on the conveyor, IR sensor turret program 600 waits for the point of interest to come within the operational range of the first IR sensor turret. In another embodiment, IR sensor turret program 600 utilizes image recognition software to identify a specific component from multiple components positioned on a PCB of the PCBA. IR sensor turret program 600 can utilize the optical camera with laser on the first IR sensor turret to scan (i.e., locate) the specific component of the PCBA by matching a scan of the specific component of the PCBA to a known image of the specific component.

IR sensor turret program 600 tracks a point of interest on the PCBA with the IR sensor turret (606). As the PCBA moves through the first temperature zone and further into the reflow oven, IR sensor turret program 600 tracks the point of interest on the PCBA with the first IR sensor turret. In response to IR sensor turret program 600 locating the point of interest on the PCBA with the first IR sensor turret, IR sensor turret program 600 tracks the point of interest on the PCBA by moving the first IR sensor turret to match a speed of the conveyor. IR sensor turret program 600 moves the first IR sensor turret by activating one or more motors and/or one or more actuators of the first IR sensor turret, such that an area for collecting thermal data by the first IR sensor turret remains over the point of interest as the PCBA moves on the conveyor. IR sensor turret program 600 tracks the point of interest on the PCBA with the first IR sensor turret until a maximum position (i.e., final position) is reach for the operational range of the first IR sensor turret.

IR sensor turret program 600 captures thermal data at the point of interest with the IR sensor turret (608). Between the anticipation position and the final position of the operational range of the first IR sensor turret, IR sensor turret program 600 captures the thermal data at the point of interest on the PCBA with the first IR sensor turret. The thermal data can include temperature readings on the surface of the point of interest on the PCBA. IR sensor turret program 600 can continuously capture the thermal data at the point of interest with the first IR sensor turret for the operational range of the first IR sensor turret and can create a temperature profile for the point of interest for the first temperature zone in the reflow oven.

IR sensor turret program 600 determines whether another IR sensor turret is available (decision 610). IR sensor turret program 600 determines whether another IR senor turret from the multiple IR sensor turrets is available until the PCBA leaves the heating zones (i.e., the temperature zones) of the reflow oven and enters a cooling zone of the reflow oven. In this embodiment, IR sensor turret program 600 determines whether a second IR sensor turret is available to capture thermal data for the point of interest. In the event IR sensor turret program 600 determines another IR sensor is available (“yes” branch, decision 610), IR sensor turret program 600 locates the point of interest on the PCBA with the other IR sensor turret (612). In the event IR sensor turret program 600 determines another IR sensor is not available (“no” branch, decision 610), IR sensor turret program 600 determines whether another PCBA is present in the reflow oven (decision 620).

IR sensor turret program 600 locates the point of interest on the PCBA with the other IR sensor turret (612). In one embodiment, IR sensor turret program 600 utilizes known dimensions for the PCBA and known coordinates to locate the point of interest on the PCBA with the IR sensor turret. Since the IR sensor turret program 600 detects the edge of a PCBA and the PCBA is in a fixed position on the conveyor, IR sensor turret program 600 utilizes the edge of PCBA as a point of reference and the speed of the conveyor when utilizes the known coordinates to locate the point of interest. As the PCBA travels on the conveyor, IR sensor turret program 600 waits for the point of interest to come within the operational range of the second IR sensor turret. In another embodiment, IR sensor turret program 600 utilizes image recognition software to identify a specific component from multiple components positioned on a PCB of the PCBA. IR sensor turret program 600 can utilize the optical camera with laser on the second IR sensor turret to scan (i.e., locate) the specific component of the PCBA by matching a scan of the specific component of the PCBA to a known image of the specific component.

IR sensor turret program 600 tracks the point of interest on the PCBA with the other IR sensor turret (614). As the PCBA moves through a second temperature zone and further into the reflow oven, IR sensor turret program 600 tracks the point of interest on the PCBA with the second IR sensor turret. In response to IR sensor turret program 600 locating the point of interest on the PCBA with the second IR sensor turret, IR sensor turret program 600 tracks the point of interest on the PCBA by moving the second IR sensor turret to match a speed of the conveyor. IR sensor turret program 600 moves the second IR sensor turret by activating one or more motors and/or one or more actuators of the second IR sensor turret, such that an area for collecting thermal data by the second IR sensor turret remains over the point of interest as the PCBA moves on the conveyor. IR sensor turret program 600 tracks the point of interest on the PCBA with the second IR sensor turret until a maximum position (i.e., final position) is reach for the operational range of the first IR sensor turret.

IR sensor turret program 600 captures thermal data the point of interest with the other IR sensor turret (616). Between the anticipation position and the final position of the operational range of the second IR sensor turret, IR sensor turret program 600 captures the thermal data at the point of interest on the PCBA with the second IR sensor turret. As previously discussed, the thermal data can include temperature readings on the surface of the point of interest on the PCBA. IR sensor turret program 600 can continuously capture the thermal data at the point of interest with the second IR sensor turret for the operational range of the second IR sensor turret and can create a temperature profile for the point of interest for the second temperature zone in the reflow oven. In some embodiments, an operational range of the first IR sensor turret can overlap with the second IR sensor turret, where IR sensor turret program 600 can capture thermal data by both the first IR sensor turret and the second IR sensor turret for a subarea of a temperature zone beneath one or more heating elements. The potential overlapping of the thermal data that IR sensor turret program 600 captures with the first IR sensor turret and the second IR sensor turret in the second temperature zone was previously discussed with regards to FIG. 2B.

IR sensor turret program 600 can utilize the overlapping thermal data to detect whether a faulty IR sensor is present in either the first IR sensor turret or the second IR sensor turret based on discrepancies in the reading. For example, IR sensor turret program 600 collects thermal data for a second temperature zone from a first IR sensor turret and a second IR sensor turret and a third temperature zone from the second IR sensor turret and a third sensor turret. IR sensor turret program 600 identifies discrepancies (i.e., meeting or exceeding a variation threshold) in a portion of temperature data values between a first set of temperature data values captured by the first IR turret and a second set of temperature data values captured by the second IR sensor turret, for the second temperature zone. However, IR sensor turret program 600 identifies no discrepancies (i.e., below a variation threshold) in a portion of temperature data values between a third set of temperature data values captured by the second IR turret and a fourth set of temperature data values captures by the third IR sensor turret, for the third temperature zone. Therefore, IR sensor turret program 600 determines a fault is present with the IR sensor on the first IR sensor turret, where the fault can require a repair, recalibration, or replacement of the IR sensor on the first IR sensor turret.

IR sensor turret program 600 returns the previous IR sensor turret to the starting position (618). In this embodiment, IR sensor turret program 600 returns the previous IR sensor turret to the starting position by moving the first IR sensor turret from the final position to the anticipation position. With IR sensor turret program 600 moving the first IR sensor turret into the anticipation position, IR sensor turret program 600 can await the arrival of another PCBA traveling on the conveyor to detect an edge of the other PCBA with the first IR sensor turret.

IR sensor turret program 600 determines whether another PCBA is present in the reflow oven (decision 620). In the event IR sensor turret program 600 determines another PCBA is present in the reflow oven (“yes” branch, decision 620), IR sensor turret program 600 reverts to detecting the edge of the other PCBA with the first IR sensor turret. In the event IR sensor turret program 600 determines another PCBA is present in the reflow oven (“no” branch, decision 620), IR sensor turret program 600 ceases operations and moves the multiple IR sensor turrets in the reflow oven to the standby position.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus comprising:
a reflow oven; and
a first infrared (IR) sensor turret suspended over a conveyor surface of the reflow oven, wherein a directional movement of the first IR sensor turret matches a directional movement of the conveyor surface.

2. The apparatus of claim 1, further comprising:
an IR sensor of the first IR sensor turret directed towards a top surface of the conveyor surface, wherein the directional movement of the first IR sensor turret dictates a directional movement of the IR sensor of the first IR sensor turret.

3. The apparatus of claim 2, further comprising:
an optical camera with laser of the first IR sensor turret directed towards the top surface of the conveyor surface.

4. The apparatus of claim 1, further comprising:
a first heating element positioned in a first temperature zone of the reflow oven, wherein an operational range of the first IR sensor turret covers a first subarea of the reflow oven beneath at least a portion of the first heat element on the conveyor surface.

5. The apparatus of claim 4, further comprising:
a second heating element positioned in a second temperature zone of the reflow oven, wherein the second heating element is adjacent to the first heating element, wherein the operational range of the first IR sensor turret covers a second subarea of the reflow oven beneath at least a portion of the second heat element on the conveyor surface.

6. The apparatus of claim 5, further comprising:
a second IR sensor turret suspended over the conveyor surface of the reflow oven, wherein a directional movement of the second IR sensor turret matches the directional movement of the conveyor surface.

7. The apparatus of claim 6, wherein an operational range of the second IR sensor turret covers a third subarea of the reflow oven beneath at least another portion of the second heat element on the conveyor surface.

8. The apparatus of claim 7, wherein the second subarea of the reflow oven beneath at least the portion of the second heat element on the conveyor surface at least partially overlaps with the third subarea of the reflow oven beneath at least the portion of the second heat element on the conveyor surface.

9. The apparatus of claim 3, further comprising:
a pivot ball of the first IR sensor turret mechanically coupled to a base, wherein the IR sensor and the optical camera with laser of the first IR sensor turret protrudes out from the pivot ball.

10. The apparatus of claim 9, wherein the pivot ball rotates in a plurality of directions with regards to the base.

11. The apparatus of claim 9, wherein the pivot ball rotates in a bidirectional manner with regards to the base and the base rotates in a bidirectional manner.

12. The apparatus of claim 5, wherein the first IR sensor turret is suspended in a first gap between the first heating element and the second heating element.

13. The apparatus of claim 12, wherein the first IR sensor turret is mechanically coupled to the first heating element.

14. The apparatus of claim 12, wherein the first IR sensor turret is mechanically coupled to the second heating element.

15. The apparatus of claim 12, wherein the first IR sensor turret is mechanically coupled to a top portion within an interior surface of the reflow oven.

16. A computer-implemented method comprising:
locating, by a first infrared (IR) sensor turret, a point of interest on a printed circuit board assembly (PCBA), wherein the PCBA is positioned on a conveyor in a reflow oven;
tracking, by the first IR sensor turret, the point of interest on the PCBA, wherein the PCBA is moving along the conveyor in the reflow oven; and
capturing, by the first IR sensor turret, a first set of thermal data at the point of interest for a first subarea of the reflow oven.

17. The computer-implemented method of claim 16, further comprising:
detecting, by the first IR sensor turret, an edge of a card for the PCBA.

18. The computer-implemented method of claim 17, wherein a first optical camera with laser of the first infrared sensor turret detects the edge of the card for the PCBA.

19. The computer-implemented method of claim 17, wherein a first IR sensor of the first infrared sensor turret detects the edge of the card for the PCBA based on a temperature variation between a temperature of heated air in the reflow oven and a temperature of a surface of the edge of the card for the PCBA.

20. The computer-implemented method of claim 17, further comprising:
responsive to determining a second IR sensor turret is available in the reflow oven, locating, by the second infrared IR sensor turret, the point of interest on the PCBA;
tracking, by the second IR sensor turret, the point of interest on the PCBA; and
capturing, by the second IR sensor turret, a second set of thermal data at the point of interest for a second subarea of the reflow oven.

21. The computer-implemented method of claim 20, further comprising:
configuring, the first IR sensor turret, from a final position to an anticipation position to detect another edge of another card for another PCBA positioned on the conveyor in the reflow oven, wherein a movement between the final position and the anticipation position defines an operational range of the first IR sensor turret.

22. The computer-implemented method of claim 21, further comprising:
detecting, by the first IR sensor turret, the other edge of the other card for the other PCBA.

23. The computer-implemented method of claim 20, wherein a portion of the first subarea overlaps with a portion of the second subarea.

24. The computer-implemented method of claim 23, wherein the first subarea corresponds to at least a first temperature zone associated with a first heating element in the reflow oven and a portion of a second temperature zone associated with a second heating element in the reflow oven.

25. The computer-implemented method of claim 24, wherein the second subarea corresponds to at least the second temperature zone associated with the second heating element in the reflow oven and a portion of a third temperature zone associated with a third heating element in the reflow oven.
